(19) United States
(12) Patent Application Publication
(10) Pub. No.: US 2008/0130547 A1
(43) Pub. Date: Jun. 5, 2008

(54) Delegated Authentication Method for Secure Mobile Multicasting

(75) Inventors: Yoo Jae Won, Gyeonggi-do (KR); Mi Youn Yoon, Seoul (KR); Seung Goo Ji, Seoul (KR); Kyu Cheol Oh, Seoul (KR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: KOREA INFORMATION SECURITY AGENCY, Seoul (KR)

(21) Appl. No.: 11/950,063

(22) Filed: Dec. 4, 2007

(30) Foreign Application Priority Data
Dec. 5, 2006 (KR) 10-2006-0121892

(51) Int. Cl. H04H 20/71; H04L 9/32

(52) U.S. Cl. 370/312; 713/168

(57) ABSTRACT

The present invention relates to a delegated authentication method for secure mobile multicasting. More specifically, the present invention relates to a delegated authentication method for secure mobile multicasting in which, when a mobile terminal in a wireless area moves from one network to another, the mobile terminal receives beacon information from an access point (AP) and the multicast secure relay server of the mobile terminal requests the multicast secure relay server controlling the access point to delegated-authenticate the mobile terminal, and after the multicast secure relay server which has received the request makes delegated-authentication, the multicast secure relay server encrypts data using the group key which the mobile terminal used before moving.

A delegated authentication method for secure mobile multicasting according to the present invention has an advantage that it can minimize a delay and a disconnection in real-time multicast streaming, which may occur while a mobile terminal is being authenticated or registered after moving to a new network. This advantage results from delegated-authentication via multicast secure relay servers each time a mobile terminal moves to a new network.

And it has an advantage that it can enforce security by using a delegated-authentication method to prevent a connection by an unauthenticated mobile terminal.

### BACKGROUND OF THE INVENTION

1. Field of the Invention

The present invention relates to a delegated authentication method for secure mobile multicasting. More specifically, the present invention relates to a delegated authentication method for secure mobile multicasting in which, when a mobile terminal in a wireless area moves from one network to another, the mobile terminal receives beacon information from an access point (AP) and the multicast secure relay server of the mobile terminal requests the multicast secure relay server controlling the access point to delegated-authenticate the mobile terminal, and after the multicast secure relay server which has received the request makes delegated-authentication, the multicast secure relay server encrypts data using the group key which the mobile terminal used before moving.

2. Background of the Related Art

Any discussion of the prior art throughout the specification should in no way be considered as an admission that such prior art is widely known or forms part of common general knowledge in this field.

Multicast is a method of simultaneously forwarding messages from a sender to many receivers, and thus reduces waste in the network resources. Multicast can be applied to group communications in a one-to-many or a many-to-many way. However, there are many limitations on conversion of a conventional unicast-based internet to a multicast network. For this reason, overlay multicast and application layer multicast have been proposed to support the multicast services in a non-multicast environment.

In addition, as a compact wireless terminal and internet services become more popular, wireless communication technologies have been changed from the conventional technologies based on data communication, in which specific contents are downloaded and used, to technologies based on various real-time multimedia services.

According to these trends, the Internet Engineering Task Force (IETF) has proposed a mobile internet protocol (IP) as a technology for providing mobility for wireless internet. A mobile IP is designed to enable a mobile terminal to stay connected during a communication session without changing its IP address, although the mobile terminal's movement during the communication session causes a change from a network to another. And also, a simple remote subscription method and a bidirectional tunneling method have been suggested to provide the function of multicast for a mobile IP.

A remote subscription method is a multicast based on a foreign agent (FA), in which, when a mobile node moves to a foreign network, a group registration is processed in the foreign network. And a bidirectional tunneling method is a multicast based on a home agent (HA), in which, when a mobile node moves to a foreign network, the mobile node receives a multicast packet through unicast tunneling from a home agent to foreign agent, without a separate process for subscription.

The multicast group communication services in a wireless environment are, unlike those in a wired environment, provided by transmitting and receiving data through a wireless channel in the air, and accordingly, have disadvantages in that they are vulnerable to the threats such as sniffing or forgery/modulation by a third party or an unauthenticated terminal, especially to the illegal receipt or usage of information or services by a masquerading user.

In addition, in a wireless environment, multicast users can communicate with one another via an access point and move while communicating. Such mobility requires all the conditions of connection to be changed automatically and dynamic connection to be maintained automatically. In this respect, it is different from the case in which a user ends all the connections to the internet at one place and starts to be connected thereto at another place. Various methods can be used to support such mobility, including a method of re-subscribing to a new multicast group with a mobile terminal connected to a current multicast group, and a tunneling method for providing services with a current multicast group maintained. However, these methods have disadvantage in that an illegal approach can be made by a masquerading mobile member's request for re-subscription or an unauthenticated request for tunneling.

### SUMMARY OF THE INVENTION

Accordingly, the present invention is directed to a delegated authentication method for secure mobile multicasting that substantially obviates one or more problems due to limitations and disadvantages of the related art.

An object of the present invention is to provide a delegated authentication method for secure mobile multicasting, which enables real-time multimedia services without a delay or a disconnection in a mobile multicast environment.

Another object of the present invention is to provide a delegated authentication method for secure mobile multicasting, which can enforce security by blocking an unauthenticated mobile terminal from being connected.

To accomplish the above objects, according to one aspect of the present invention, there is provided a delegated authentication method for secure mobile multicasting, comprising: a first step of allowing a first multicast secure relay server to request a second multicast secure relay server to delegated-authenticate a mobile terminal, when the mobile terminal which subscribes to the first multicast secure relay server is in a hand-off; a second step of allowing the second multicast secure relay server to try delegated-authenticating the mobile terminal; a third step of allowing the second multicast secure relay server to transmit multicast data to the mobile terminal and allowing the mobile terminal to construct an internet protocol (IP) address; and a fourth step of allowing the first and the second multicast secure relay servers to join and leave the multicast group of the mobile terminal, and allowing the second multicast secure relay server to transmit the multicast data encrypted using its group key to the mobile terminal.

It is to be understood that both the foregoing general description and the following detailed description of the present invention are exemplary and explanatory and are intended to provide further explanation of the invention as claimed.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a configuration of a system for supporting mobility for a mobile terminal in a mobile multicast environment, in accordance with an embodiment of the present invention; and

FIG. 2 a flowchart which shows a process for delegated-authenticating a mobile terminal by multicast secure relay servers, in accordance with an embodiment of the present invention.

### DETAILED DESCRIPTION OF THE PREFERRED EMBODIMENT

The present invention will now be described more fully with reference to the accompanying drawings, in which exemplary embodiments of the invention are shown. The invention may, however, be embodied in many different forms and should not be construed as being limited to the embodiments set force herein, rather, these embodiments are provided so that this disclosure will be thorough and complete, and will fully convey the concept of the invention to those skilled in the art.

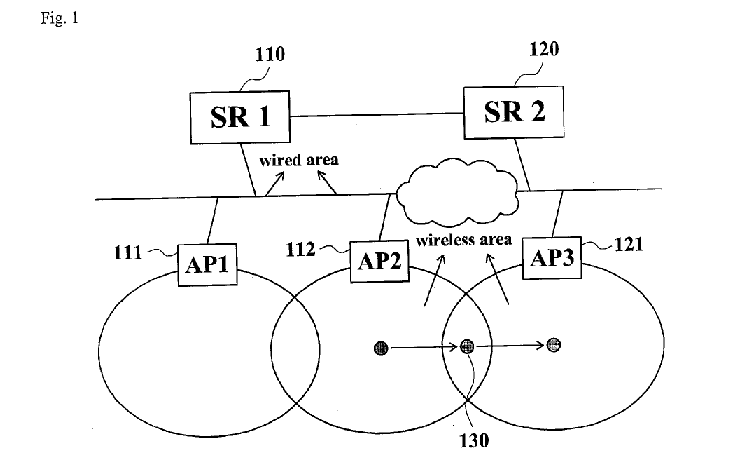

FIG. 1 illustrates a configuration of a system for supporting mobility for a mobile terminal in a mobile multicast environment, in accordance with an embodiment of the present invention

As shown in FIG. 1, a delegated authentication system according to an embodiment of the present invention comprises: a mobile terminal 130 for transmitting and receiving data in a wireless network environment, a first multicast secure relay server 110 and a second multicast secure relay server 120 for delegated-authenticating the mobile terminal 130; and access points (AP) 111, 112 and 121 for managing the multicast secure relay servers 110 and 120.

Each multicast secure relay server manages a group key using a different multicast address to provide group security for a local group, and updates a group key in case of joining or leaving of a member.

Access point (AP) list information, which is inputted by a network operator, comprises: an AP identifier, a media access control (MAC) address of an AP, a network identifier, an address of a multicast secure relay server managing an AP.

Referring to FIG. 1, a method for supporting mobility in mobile multicast service in accordance with an embodiment of the present invention is as follows: a mobile terminal 130 monitors strength of the signals transmitted from access points 111, 112 and 121 at a specific time interval. When the signal from the access point currently managing the mobile terminal has an strength less than a threshold value, the mobile terminal searches a new access point (AP) 121 to be connected to. When the strength of the signal from the neighboring access point 121 continuously increases to become similar to that from the access point 112 currently managing the mobile terminal, a hand-off of the mobile terminal 130 occurs in the access point list information and the mobile terminal 130 requests delegated-authentication to the first multicast secure relay server 10.

The second multicast secure relay server 120 encrypts and transmits multicast data using the group key of the first multicast secure relay server until a new address is allocated to the mobile terminal 130 with the group key provided by the first multicast secure relay server 110. When a mobile IP address is allocated to the mobile terminal 130 in a new network, the second multicast secure relay server 120 updates the group key of the mobile terminal 130 using its group key, and transmits to the mobile terminal multicast data encrypted using its group key. In this way, the second multicast secure relay server 120 continuously transmits data to the mobile terminal 130 while the mobile terminal moves between networks. This can minimize a delay or a disconnection in multicast services.

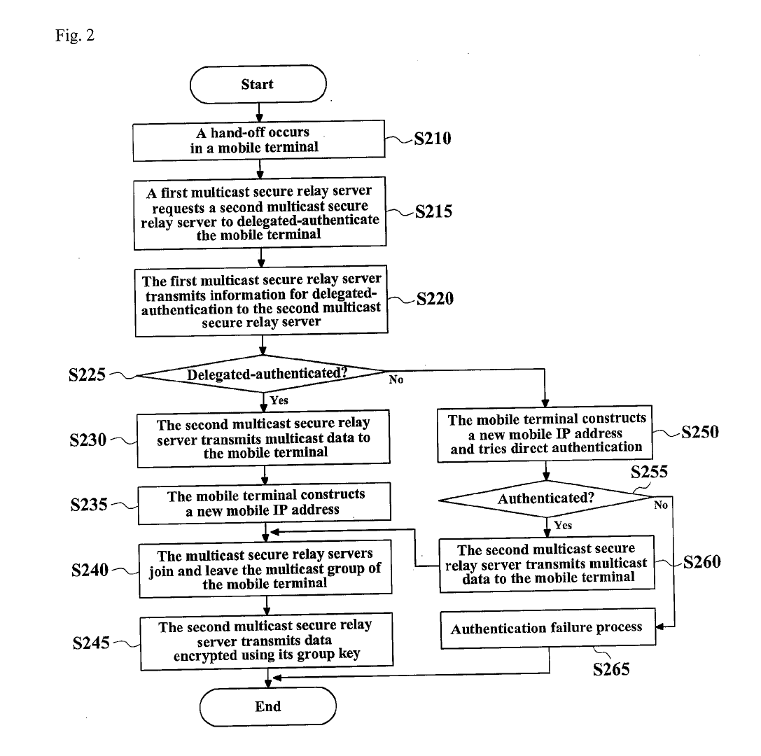

FIG. 2 a flowchart which shows a process for delegated-authenticating a mobile terminal by multicast secure relay servers, in accordance with an embodiment of the present invention.

First, a hand-off occurs in a mobile terminal 130 which moves from one wireless network to another in S210. The mobile terminal 130 in a hand-off transmits to a first multicast secure relay server 110 a message for requesting delegated-authentication (the identification (ID), the password and the individual key of the mobile terminal) in S215. The first multicast secure relay server 110 transmits to a second multicast secure relay server 120 the information for delegated-authentication (the message for requesting delegated-authentication, the group key and the multicast group information) in S220. After receiving the information, the second multicast secure relay server 120 tries delegated-authenticating the mobile terminal in S225.

If the second multicast secure relay server 120 delegated-authenticates the mobile terminal, it transmits to the mobile terminal 130 multicast data encrypted using the group key of the first multicast secure relay server 110 in S230, to block multicasting from being disconnected. In case that broadcasting services are provided to the multicast group of the second multicast secure relay server 120, the second multicast secure relay server transmits to the mobile terminal 130 multicast data encrypted using the group key of the first multicast secure relay server 110. And in case that broadcasting services are not provided to the multicast group of the second multicast secure relay server 120, the second multicast secure relay server 120 transmits to the mobile terminal 130 the multicast data which the second multicast secure relay server 120 has received from the first multicast secure relay server 110 through tunneling for multicasting.

And then, the mobile terminal 130 constructs a new mobile internet protocol (IP) address in S235. At this time, in case of an internet protocol version 6 (IPv6) environment, the mobile terminal requests a prefix from the second multicast secure relay server 120 and receives a prefix advertisement message and then constructs a new mobile IP address. In case of an internet protocol version 4 (IPv4) environment, the mobile terminal sends a message for requesting a mobile IP to a dynamic host configuration protocol (DHCP) (not shown) of the network to which it has moved, to construct a new mobile IP address.

After that, the first multicast secure relay server 110 requests the second multicast secure relay server 120 to subscribe to the multicast group of the mobile terminal 130, and the second multicast secure relay server 120 requests the first multicast secure relay server 110 to leave the multicast group of the mobile terminal 130, in S240. In response to the requests, the multicast secure relay servers 110 and 120 compare the identifications, the passwords, the individual keys, etc. with regard to the mobile terminal 130, and then change the information in the list of multicast group members. In addition, the second multicast secure relay server 120 updates the group key of the mobile terminal 130 using its group key. In S245, the second multicast secure relay server 120 transmits multicast data encrypted using its group key to the mobile terminal 130.

If the second multicast secure relay server 120 fails to delegated-authenticate the mobile terminal in S225, the mobile terminal 130 requests the second multicast secure relay server 120 to authenticate the mobile terminal 130 after constructing a new mobile internet protocol (IP) address, in S250. At this time, in case of an internet protocol version 6 (IPv6) environment, the mobile terminal requests a prefix from the second multicast secure relay server 120 and receives a prefix advertisement message and then constructs a new mobile IP address. In case of an internet protocol version 4 (IPv4) environment, the mobile terminal sends a message for requesting a mobile IP to a dynamic host configuration protocol (DHCP) (not shown) of the network to which it has moved, to construct a new mobile IP address.

If the mobile terminal 130 is directly authenticated in S255, the second multicast secure relay server 120 transmits multicast data encrypted using the group key of the first multicast secure relay server 110 in S260 and then the process of S240 and the later processes are performed.

If the mobile terminal 130 fails to be directly authenticated in S255, the second multicast secure relay server 120 makes a proper process for “authentication failure” and ends multicasting to the mobile terminal 130.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

A delegated authentication method for secure mobile multicasting according to the present invention has an advantage that it can minimize a delay and a disconnection in real-time multicast streaming, which may occur while a mobile terminal is being authenticated or registered after moving to a new network. This advantage results from delegated-authentication via multicast secure relay servers each time a mobile terminal moves to a new network.

And it has an advantage that it can enforce security by using a delegated-authentication method to prevent a connection by an unauthenticated mobile terminal.

What is claimed is:

1. A delegated authentication method for secure mobile multicasting, comprising:
a first step of allowing a first multicast secure relay server to request a second multicast secure relay server to delegated-authenticate a mobile terminal, when the mobile terminal which subscribes to the first multicast secure relay server is in a hand-off;
a second step of allowing the second multicast secure relay server to try delegated-authenticating the mobile terminal;
a third step of allowing the second multicast secure relay server to transmit multicast data to the mobile terminal and allowing the mobile terminal to construct an internet protocol (IP) address; and
a fourth step of allowing the first and the second multicast secure relay servers to join and leave the multicast group of the mobile terminal, and allowing the second multicast secure relay server to transmit the multicast data encrypted using its group key to the mobile terminal.

2. The delegated authentication method of claim 1, wherein the first step is characterized in that the mobile terminal transmits information for delegated-authentication, the information being at least one of the group consisting of the identification, password and individual key, the group key and the multicast group information of the mobile terminal.

3. The delegated authentication method of claim 1, wherein the second step further comprises:
a step of going to the third step, if the second multicast secure relay server delegated-authenticates the mobile terminal; and
a step of allowing the mobile terminal to construct a new mobile IP address and request the second multicast secure relay server to delegated-authenticate the mobile terminal, if the second multicast secure relay server fails to delegated-authenticate the mobile terminal.

4. The delegated authentication method of claim 3, wherein the step of going to the third step further comprises:
a step of allowing the mobile terminal to receive the multicast data from the second multicast secure relay server and going to the fourth step, if the mobile terminal is authenticated; and
a step of ending broadcasting, if the mobile terminal fails to be authenticated.

5. The delegated authentication method of claim 4, wherein the multicast data comprises:
multicast data encrypted by the second multicast secure relay server using the group key of the first multicast secure relay server, if broadcasting services are provided to the multicast group of the second multicast secure relay server; and
multicast data received by the second multicast secure relay server from the first multicast secure relay server through tunneling for multicasting, if broadcasting services are not provided to the multicast group of the second multicast secure relay server.

6. The delegated authentication method of claim 1, wherein the multicast data of the third step comprises:
multicast data encrypted by the second multicast secure relay server using the group key of the first multicast secure relay server, if broadcasting services are provided to the multicast group of the second multicast secure relay server; and
multicast data received by the second multicast secure relay server form the first multicast secure relay server through tunneling for multicasting, if broadcasting services are not provided to the multicast group of the second multicast secure relay server.

7. The delegated authentication method of claim 1, wherein the fourth step further comprises:
a step of allowing the first multicast secure relay server and the second multicast secure relay server to change the information in a list of the multicast members; and
a step of allowing the second multicast secure relay server to update a group key of the mobile terminal using its group key.
